(19) United States
(12) Patent Application Publication
(10) Pub. No.: US 2008/0156897 A1
(43) Pub. Date: Jul. 3, 2008

(54) LOW SPEED PULSATING SHOWERHEAD

(75) Inventor: Leland C. Leber, Fort Collins, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Water Pik, Inc., Fort Collins, CO (US)

(21) Appl. No.: 11/964,670

(22) Filed: Dec. 26, 2007

Related U.S. Application Data
(60) Provisional application No. 60/882,441, filed on Dec. 28, 2006.

(51) Int. Cl. B05B 1/08; B05B 3/02

(52) U.S. Cl. 239/101; 239/383

(57) ABSTRACT

A showerhead may include a housing, a jet disk, a turbine, and a shutter. The housing may include a fluid inlet, at least one fluid outlet, and a chamber in fluid communication with the inlet and one or more outlets. The jet disk, turbine, and shutter may be placed in the cavity. The shutter may include at least one opening. The shutter may selectively cover and uncover fluid outlets, thus selectively fluidly connecting the fluid outlets with the chamber. Water flowing through the housing causes the turbine to spin. As the turbine spins, the shutter rotates at a slower speed than the turbine to produce a periodic interruption of water flow through the outlets by covering and uncovering the outlets as the shutter rotates within the housing.

### CROSS-REFERENCE TO RELATED APPLICATIONS

This application claims the benefit under 35 U.S.C. § 119(e) to U.S. Provisional Application No. 60/882,441, titled “Low Speed Pulsating Shower Head” and filed on Dec. 28, 2006, which is hereby incorporated by reference herein in its entirety.

### BACKGROUND OF THE INVENTION

1. Field of the Invention

The present invention relates generally to showerheads, and more specifically to pulsating showerheads.

2. Background Art

Generally, showerheads are used to direct water from the home water supply onto a user for personal hygiene purposes. Showers may provide an alternative to bathing in a bath tub.

In the past, bathing was the overwhelmingly popular choice for personal cleansing. However, in recent years showers have become increasingly popular for several reasons. First, showers generally take less time than baths. Second, showers generally use significantly less water than baths. Third, shower stalls and bath tubs with showerheads are typically easier to maintain. Fourth, showers tend to cause less soap scum build-up.

With the increase in popularity of showers has come an increase in showerhead designs and showerhead manufacturers. Many showerheads, for example, may emit pulsating streams of water in a so-called “massage” mode. Yet others are referred to as “drenching” showerheads, since they have relatively large faceplates and emit water in a steady, soft spray pattern.

### BRIEF SUMMARY OF THE INVENTION

Various embodiments of a showerhead may include a housing, a turbine, and a shutter. The housing may define a chamber in fluid communication with a fluid inlet and at least one fluid outlet. The turbine may be received within the chamber. The shutter may be received within the chamber and operatively associated with the turbine. Rotation of the turbine may cause rotation of the shutter. A rotation rate of the shutter may be less than a rotation rate of the turbine. As the shutter rotates, the shutter may fluidly connect and disconnect the fluid inlet and the at least one fluid outlet.

In some showerhead embodiments, the housing may include a first engagement feature, the shutter may include a second engagement feature, and engagement of the first engagement feature with the second engagement feature may cause the rotation rate of the shutter to be less than the rotation rate of the turbine. The first engagement feature, the second engagement feature, or both, may be at least one gear tooth.

In yet further showerhead embodiments, the shutter may include at least one opening, and the at least one opening may fluidly connect and disconnect the fluid inlet and the at least one fluid outlet. In yet more showerhead embodiments, the shutter may include a disk and an integer number of first features distributed around a periphery of the disk, the housing may include an integer number of second features incorporated within an inner surface of the housing defining the chamber, the number of first features may be different than the number of second features, and rotation of the shutter may selectively engage the first features with the second features.

### BRIEF DESCRIPTION OF THE DRAWINGS

FIG. 1 depicts a perspective view of a first embodiment of a showerhead.

FIG. 2 depicts another perspective view of the showerhead shown in FIG. 1.

FIG. 3 depicts a cross-section view of the showerhead shown in FIG. 1, viewed along line 3-3 in FIG. 2.

FIG. 4 depicts an exploded perspective view of the showerhead shown in FIG. 1.

FIG. 5 depicts another exploded perspective view of the showerhead shown in FIG. 1.

FIG. 6 depicts another cross-section view of the showerhead shown in FIG. 1, viewed along line 6-6 in FIG. 3.

FIG. 7 depicts yet another cross-section view of the showerhead shown in FIG. 1, viewed along line 7-7 in FIG. 3.

FIG. 8 depicts still yet another cross-section view of the showerhead shown in FIG. 1, showing a view similar to the view shown in FIG. 7.

FIG. 9 depicts a cross-section view of the showerhead shown in FIG. 1 similar to the view shown in FIG. 8, showing the position of the shutter openings relative to the showerhead outlets after the turbine has moved one complete revolution from the position shown in FIG. 8.

FIG. 10 depicts a cross-section view of the showerhead shown in FIG. 1 similar to the view shown in FIG. 8, showing the position of the shutter openings relative to the showerhead outlets after the turbine has moved two complete revolutions from the position shown in FIG. 8.

FIG. 11 depicts a cross-section view of the showerhead shown in FIG. 1 similar to the view shown in FIG. 8, showing the position of the shutter openings relative to the showerhead outlets after the turbine has moved three complete revolutions from the position shown in FIG. 8.

FIG. 12 depicts yet a further cross-section view of the showerhead shown in FIG. 1, showing a view similar to the view shown in FIG. 7 and showing the cam in a first position.

FIG. 13 depicts a cross-section view of the showerhead shown in FIG. 1 similar to the view shown in FIG. 12, showing the cam in a second position and the relationship of the perimeter of the shutter to the housing when the cam is in the second position.

FIG. 14 depicts a cross-section view of the showerhead shown in FIG. 1 similar to the view shown in FIG. 12, showing the cam in a third position and the relationship of the perimeter of the shutter to the housing when the cam is in the third position.

FIG. 15 depicts a cross-section view of the showerhead shown in FIG. 1 similar to the view shown in FIG. 12, showing the cam in a fourth position and the relationship of the perimeter of the shutter to the housing when the cam is in the fourth position.

FIG. 16 depicts a perspective view of a second embodiment of a showerhead.

FIG. 17 depicts another perspective view of the showerhead shown in FIG. 16.

FIG. 18 depicts a cross-section view of the showerhead shown in FIG. 16, viewed along line 18-18 in FIG. 16.

FIG. 19 depicts an exploded perspective view of the showerhead shown in FIG. 16.

FIG. 20 depicts another exploded perspective view of the showerhead shown in FIG. 16.

FIG. 21 depicts another cross-section view of the showerhead shown in FIG. 1, viewed along line 21-21 in FIG. 18.

FIG. 22 depicts a cross-section view of the showerhead shown in FIG. 16 similar to the view shown in FIG. 21, showing the position of the shutter opening relative to the housing after rotation of the shutter within the housing.

FIG. 23 depicts a top view of the housing for the showerhead shown in FIG. 25.

FIG. 24 depicts a top view of the shutter for the showerhead shown in FIG. 16.

FIG. 25 depicts a bottom view of the turbine for the showerhead shown in FIG. 16.

FIG. 26 depicts a top view of another housing for the showerhead shown in FIG. 16.

FIG. 27 depicts another cross-section view of the showerhead shown in FIG. 16 similar to the view shown in FIG. 18, showing another shutter for the showerhead shown in FIG. 16 positioned within the housing shown in FIG. 26.

### DETAILED DESCRIPTION

Described herein are showerheads for generating a relatively low speed pulsating spray. The showerheads may include a jet disk, a turbine, a shutter, and a housing. Water flowing through the showerhead causes the turbine to spin. As the turbine spins, it rotates the shutter. The shutter may be configured to rotate at a slower speed than the turbine to produce a periodic interruption of water flow through outlets or nozzles defined in, or attached to, the housing to create a pulsating spray. This pulsating spray may simulate the feel of a hand massage.

The shutter may take the form of a generally circular disk including gear teeth that selectively engage gear teeth in the housing. The turbine may include an offset cam that drives the shutter. The speed reduction achieved is the ratio of the difference in the number of gear teeth of the housing and the shutter to the number of gear teeth on the shutter. Expressed mathematically, this may be written as: (Housing Teeth-Shutter Teeth)/(Shutter Teeth).

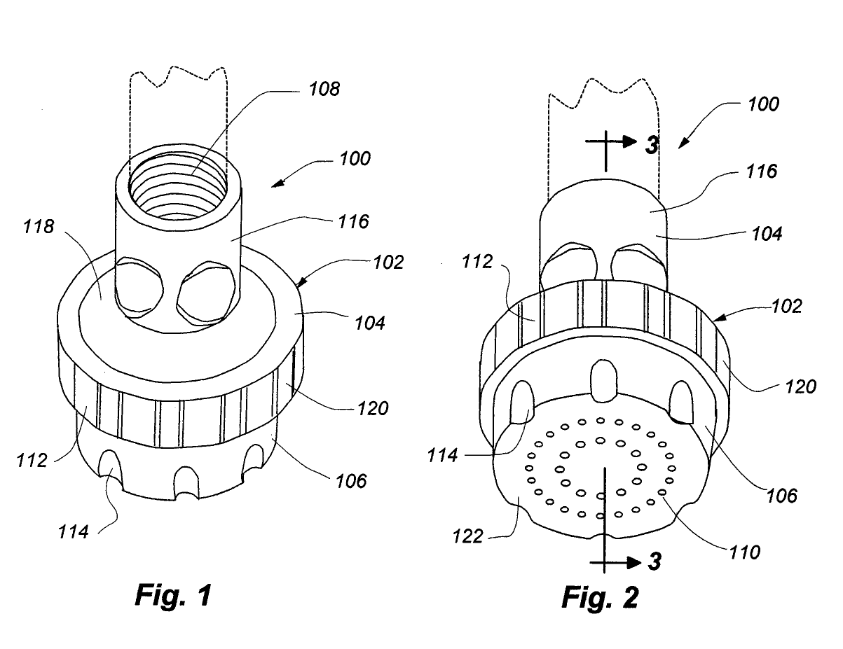

FIGS. 1-15 depict various views of a first embodiment of a showerhead 100. With reference to FIGS. 1 and 2, the showerhead 100 may include a housing 102. The housing 102 may be formed from upper and lower housing portions 104, 106. The upper housing portion 104 may include a fluid inlet for receiving fluid from a fluid source. The upper housing portion 104 may further include threads 108 proximate the fluid inlet for threadedly joining the showerhead 100 to a shower pipe, flexible arm, hose connector, arm assembly, or other device for conveying fluid, such as water, (i.e., a fluid source) to the showerhead 100. Although shown as threadedly joined to the fluid conveying device, the showerhead 100 may be attached to the fluid conveying device using any known connection method or combination of methods, including, but not limited to, press fitting, clamping, welding, and so on. The lower housing portion 106 may include one or more fluid outlets 110 in selective fluid communication with the fluid inlet. The fluid outlets 110 may be generally circular holes or any other suitably shaped hole or opening. A fluid, such as water, may be delivered from a fluid source to a user via the showerhead 100 through at least one of the fluid outlets 110.

The upper housing portion 104, the lower housing portion 106, or both portions may include user engagement features to facilitate joining the portions. For example, the upper and lower portions 104, 106 as shown in FIGS. 1 and 2 may each include recessed surfaces 112, 114 for providing a surface for a user to grip. In other embodiments, the upper housing portion 104, the lower housing portion 106, or both may incorporate other types of user engagement features, or combinations of features, such as raised protrusions, tabs, roughened surfaces, and so on, that may enhance a user's grip on the upper housing portion 104, the lower housing portion 106, or both portions for joining the portions, moving the showerhead 100 relative to a shower pipe or other device for conveying fluid to the showerhead, and/or selecting a showerhead operating mode.

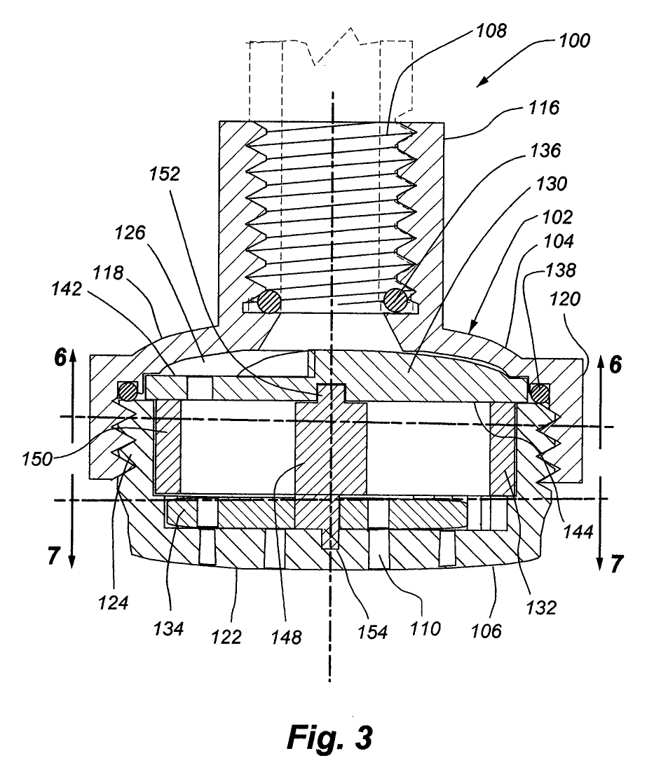

Turning to FIGS. 3-5, the upper housing portion 104 may include a generally cylindrical housing shaft 116 defining a fluid passage. The fluid passage may be in fluid communication with the fluid inlet. A generally annular housing flange 118 may extend radially outward from a lower portion of the housing shaft 116. A generally circular upper housing sidewall 120 may extend generally downward from the housing flange 118. An inner surface of the upper housing sidewall 120 may include threads for joining the upper housing portion 104 to the lower housing portion 106. A flow restrictor (not shown), as known in the art, may be positioned in the fluid passage to limit fluid flow through the showerhead 100 from a fluidly connected fluid source.

The lower housing portion 106 may include a generally circular lower housing base 122. A generally circular lower housing sidewall 124 may extend upward from the lower housing base 122. An external surface of the lower housing sidewall 124 may include threads configured to engage the upper housing threads.

The upper and lower housing threads may be engaged to join the upper housing portion 104 to the lower housing portion 106. Although the upper housing threads are shown as internal threads and the lower housing threads are shown as external threads, the upper housing threads could be external and the lower housing threads could be internal. Further, the upper and lower housing portions 104, 106 may be joined by any known connection method, including, but not limited to, press fitting, clamping, welding, the aforementioned threading, and so on.

The upper housing portion 104 and the lower housing portion 106 may define a chamber or cavity 126. The chamber or cavity 126 may be defined by the upper housing flange 118, the lower housing sidewall 124, and the lower housing base 122. The chamber or cavity 126 may be generally cylindrical in shape or any other desired shape. The chamber or cavity 126 may be in fluid communication with the upper housing fluid passage and in selective fluid communication with the fluid outlets 110.

Although the shape and configuration of the upper and lower housing portions 104, 106 are described and shown with a certain particularity, the upper and lower housing portions 104, 106 may take the form of any desired shape to define the exterior and the interior of the housing 102. Further, the housing 102 may be formed from more or less than two housing portions. Yet further, although the housing 102 is shown as including one fluid inlet, one fluid passage, and one chamber or cavity, the housing may include or define more than one of any of these elements. For example, the housing 102 may define two fluid inlets, two fluid passages, and/or two chambers or cavities. The foregoing example is merely illustrative and is not intended to imply for the housing 102 any particular number or arrangement of fluid inlets, fluid passages, or chambers or cavities.

With continued reference to FIGS. 3-5, the showerhead 100 may further include a jet disk 130, a turbine 132, a shutter 134, and one or more sealing members 136, 138. The jet disk 130, the turbine 132, and the shutter 134 may be received within the cavity or chamber 126 defined by the housing 102. A fluid source seal member 136 may be positioned within the fluid inlet of the upper housing portion 104, and a housing seal member 138 may be positioned between the upper and lower housing portions 104, 106 proximate the area where these portions are joined.

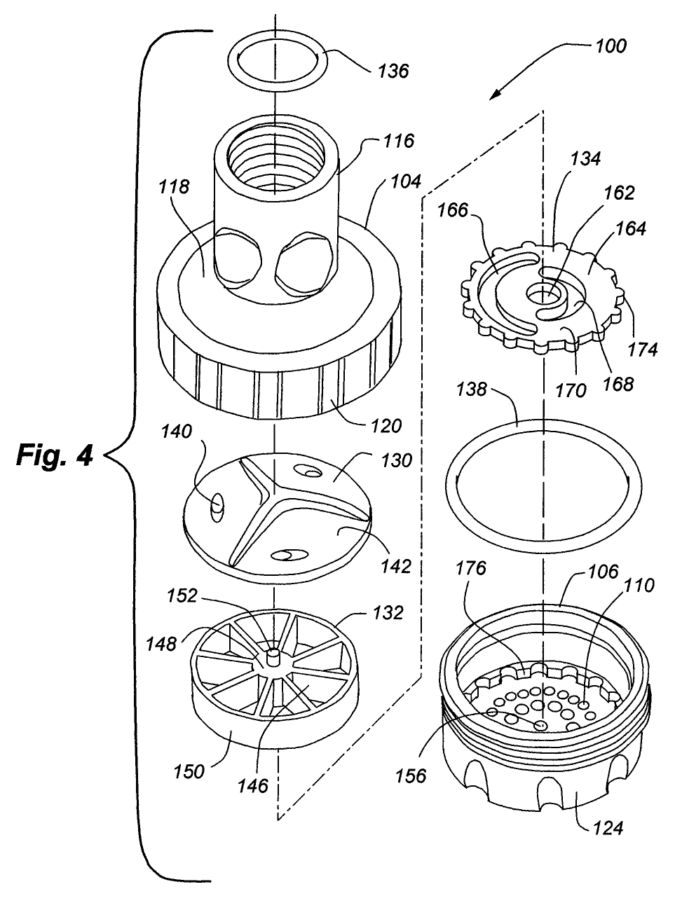

The jet disk 130 may include a generally circular and planar body or any other suitably shaped body. The jet disk 130 may include one or more jet disk fluid jets or openings 140. Although three jets 140 are shown in FIGS. 4 and 5, the jet disk 130 may include more or less than three jets. Each jet 130 may extend from an upper to a lower surface 142, 144 of the jet disk 130, thus creating a path for fluid to flow from the jet disk's upper surface 142 to its lower surface 144. Further, the jets 140 may be angled relative to the jet disk's upper and lower surfaces 142, 144 to impart a directional flow to fluid passing through them. Such directional flow may cause the turbine 132 to rotate within the showerhead cavity 126. The jets 140 may also be shrouded, which may increase the fluid's flow speed. Alternative embodiments may vary the number of jets 140 employed and/or the shrouding configuration.

The turbine 132 may take the form of a generally hollow open-ended cylinder with blades 146 extending radially inward toward a central hub 148 from a generally circular turbine wall 150. The turbine wall 150, or at least a portion of the turbine wall 150, may be omitted in some embodiments. Further, the number of blades 146 may be more or less than the number depicted in the figures. The turbine 132 may include a first pin-shaped extrusion 152 extending generally upward from its upper side and a second pin-shaped extrusion 154 extending generally downward from its lower side. Each pin-shaped extrusion 152, 154 may be located along a central axis of the turbine 132. The lower pin-shaped extrusion 154 may be received in an opening 156 in the housing 102 and the upper pin-shaped extrusion 152 may be received in an opening 158 in the jet disk 130. The turbine 132 may rotate about its central axis (i.e., about the pin-shaped extrusions 152, 154). Alternatively, the turbine 132 may have an upper opening that receives a pin shaped extrusion extending from a lower side of the jet disk 130 and a lower opening that receives a pin shaped extrusion extending from the housing 102.

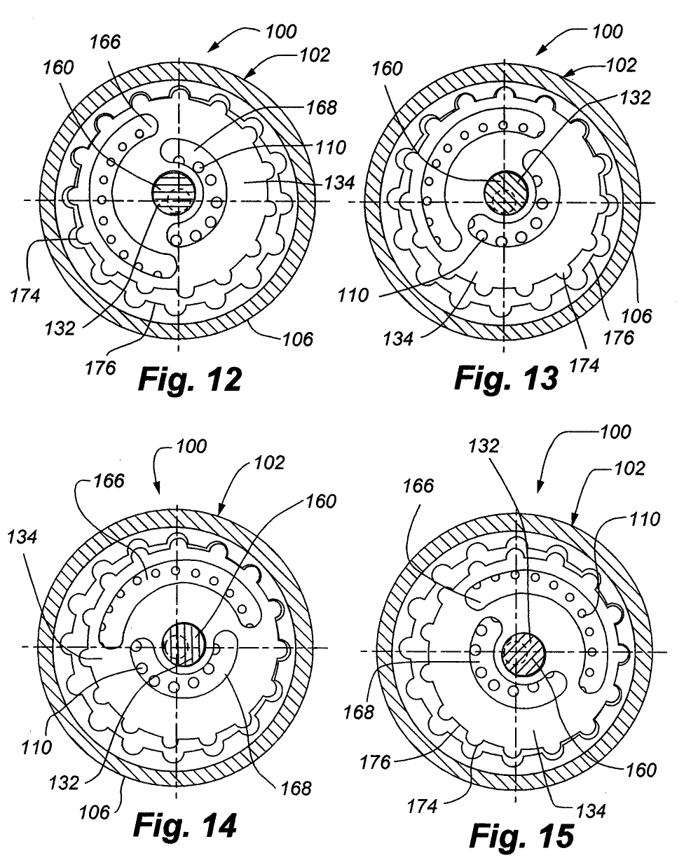

The turbine 132 may include an eccentric cam 160 on its lower side (i.e., the side facing the shutter 134). The shutter 134 may take the form of a generally circular and planar body or any other desired shape and may include an opening 162 along its central axis to receive the eccentric cam 160. The shutter 134 may thus spin about the central axis of the eccentric cam 160 as the turbine 132 rotates. The center of the eccentric cam 160 is off-center with respect to the center axis of the turbine 132 and housing 102. Thus, as the turbine 132 spins, the eccentric cam 160 moves the center of the shutter 134 in a generally circular path around the center axis of the turbine 132 and the housing 102. As the center of the shutter 134 moves in this generally circular path, the portion of its perimeter that engages or otherwise contacts the lower housing portion's side wall 124 changes as shown, for example, in FIGS. 12-15.

The shutter body 164 may include one or more fluid openings 166, 168 through its thickness for water to pass from the upper side 170 to the lower side 172 of the shutter 134. The shutter fluid openings 166, 168 may be selectively aligned with at least some of the outlets 110 in the housing 102. When aligned, water or other fluid may flow from the housing chamber or cavity 126 and out of the outlets 110 aligned with the shutter fluid openings 166, 168. The shutter 134 may include an engagement feature 174, which may take the form of gear teeth or the like. The gear teeth may be, although not necessarily, uniformly distributed around the shutter body's periphery.

The housing 102 may include a housing engagement feature 176 to engage the shutter's engagement feature. The housing engagement feature may be engaging teeth complementary to the shutter's gear teeth. These may be, but not necessarily, equally spaced around the interior periphery of the lower housing portion 106. As shown, for example, in FIG. 7, the shutter 134 may include fifteen gear teeth, and the housing 102 may include sixteen housing teeth. Other embodiments may use a different number of gear teeth for the shutter 134 and/or housing 102. At least some of the shutter's gear teeth may engage the housing's gear teeth. Further, as the turbine 132 rotates, the gear teeth of the shutter 134 that engage the gear teeth of the housing 102 may change.

Returning to FIGS. 3-5, the fluid source seal member 136 may form a fluid seal between the showerhead 100 and a fluid source joined to the showerhead 100. More particularly, the fluid source seal member 136 may substantially limit or otherwise prevent fluid leakage from the showerhead 100 along the threaded joint that joins that fluid source to the showerhead 100. The housing seal member 138 may form a fluid seal between the upper and lower housing portions 104, 106 to substantially limit or otherwise prevent fluid leakage from the showerhead 100 along the threaded joint that joins the upper housing portion 104 to the lower housing portion 106. The fluid source and housing seal members 136, 138 may take the form of O-rings or any other suitable element that provides a fluid seal between two or more members or components and may be composed of an elastomeric material, such as rubber, or any other known fluid sealant material.

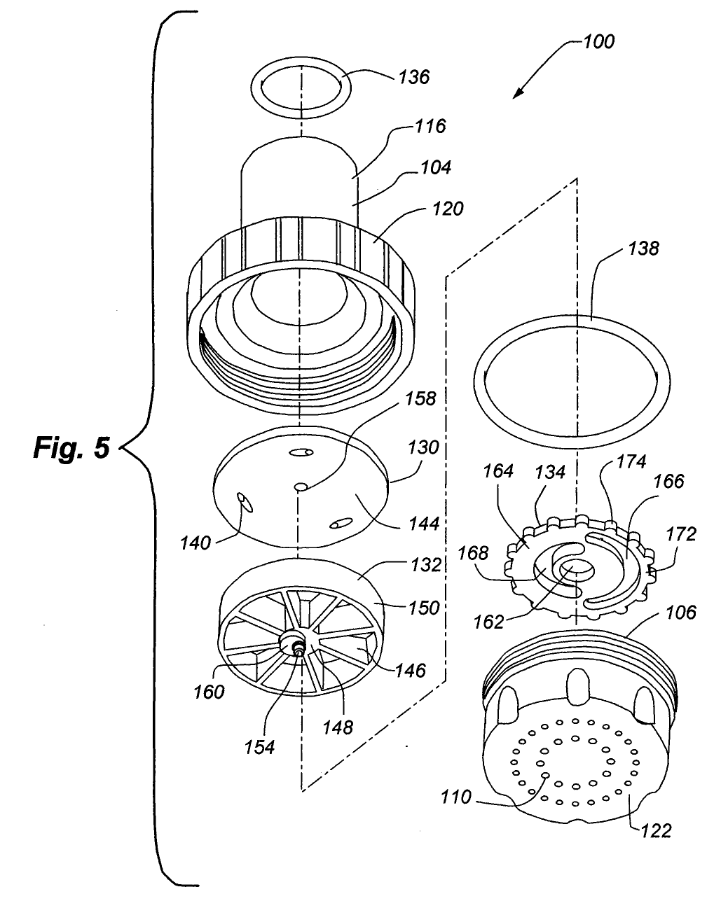

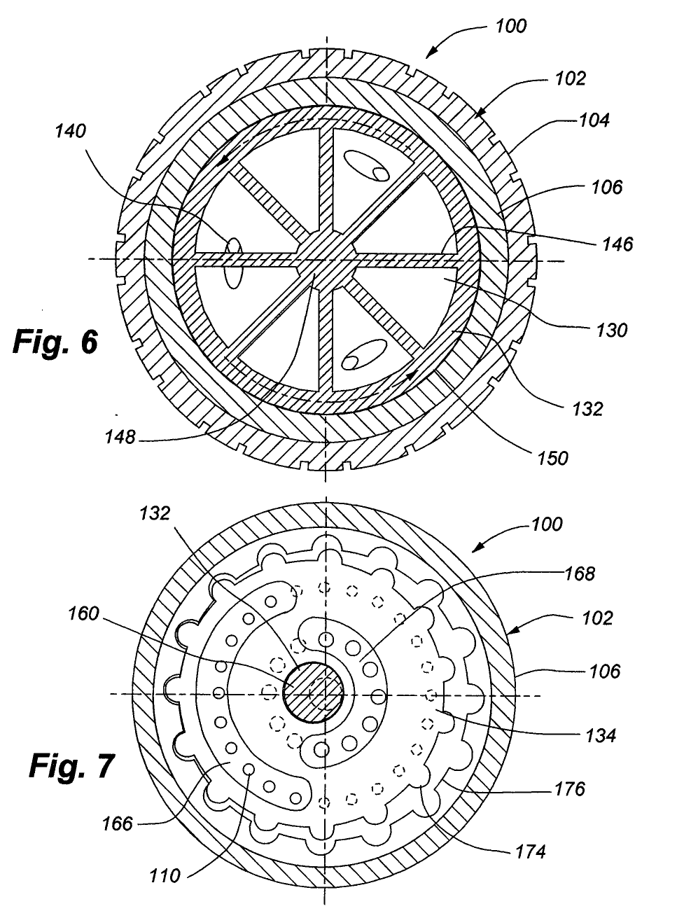

Operation of the showerhead 100 will now be described with reference to FIGS. 3, 6 and 7. Water or other fluid may flow through the fluid inlet from the fluid source to the jet disk 130. As water or other fluid passes through the jets 140, it impacts one or more blades 146 of the turbine 132, which is situated within the housing 102 between the shutter 134 and the jet disk 130. Water impacting the turbine blades 146 imparts rotational motion to the turbine 132. As viewed from the side of the turbine 132 facing the shutter 134 as shown, for example, in FIG. 6, the turbine 132 may rotate in a clockwise fashion. Alternative embodiments may cause the turbine 132 to rotate in a counterclockwise fashion. After impacting the turbine blades 146, the water hits the upper side 170 of the shutter 134.

As the turbine 132 rotates from water impacting its blades 146, the turbine 132 causes the center of the shutter 134 to move in a generally circular motion via the aforementioned connection between the shutter 134 and the turbine's eccentric cam 160. This meshes at least some of the external teeth of the shutter 134 with some of the internal teeth of the housing 102 resulting in rotational movement of the shutter 134 relative to the turbine 132. Additionally, the teeth of the shutter 134 and housing 102 disengage at a side of the shutter 134 approximately opposite the point of engagement as shown, for example, in FIG. 7 and FIGS. 12-15.

Since the shutter 134 has one less tooth than the housing 102 and tooth disengagement between the shutter 134 and the housing 102 is made possible by motion of the center of the shutter 134 in a generally circular path around the central axis of the turbine 132, each complete revolution of the turbine 132 results in a one tooth displacement of the shutter 134 in relation to the housing 102. This displacement is in the opposite direction of the rotation of the turbine 132. For example, if the turbine 132 is rotating in a clockwise direction, the one tooth displacement of the shutter 134 relative to the housing 102 will be in a counter-clockwise direction and vice versa. Thus, selective engagement of the shutter teeth with the housing teeth functions as a speed reduction mechanism because the shutter 134 rotates 1/15th as quickly as it would absent this engagement.

The speed reduction achieved (i.e., how fast the shutter 134 rotates relative to how fast the turbine 132 rotates) is determined by the ratio of the difference between number of engagement features 175, 176 of the housing 102 and the shutter 134 to the number of engagement features 174 on the shutter 134. For the showerhead depicted in FIGS. 1-15, a speed reduction of 1/15^{th} occurs since the housing 102 has sixteen gear teeth and the shutter 134 has fifteen gear teeth. That is, the shutter 134 rotates at 1/15^{th} the rotational speed of the turbine 132.

In other embodiments, the shutter 134 may have 30 gear teeth and the housing 102 may have 31 gear teeth. This causes the shutter 134 to turn in the opposite direction of the turbine 132 by 1/30^{th} of the rotational rate of the turbine 132. In other words, the shutter 134 rotates approximately 1/30^{th} about its central axis each time the turbine 132 completes one revolution, and the shutter 134 rotates in the opposite direction of the turbine 132. Accordingly, the shutter 134 completes a complete revolution in the opposite direction of the turbine 132 each time the turbine 132 completes 30 revolutions. In yet other embodiments, the shutter 134 may have more engagement teeth than the housing 102, which causes the shutter 134 to rotate in the same direction as the turbine 132, albeit at a slower rate. For example, some embodiments may use a shutter 134 with thirty gear teeth and a housing 102 with twenty-eight housing teeth. This causes the shutter 134 to precess, i.e., turn in the same direction as the turbine 132, at a rate of 1/15^{th} the speed of the turbine 132. Other embodiments may employ a shutter 134 and a housing 102 with more or fewer teeth to achieve a desired speed reduction and direction of rotation of the shutter 134 relative to the rotational speed and direction of rotation of the turbine 132.

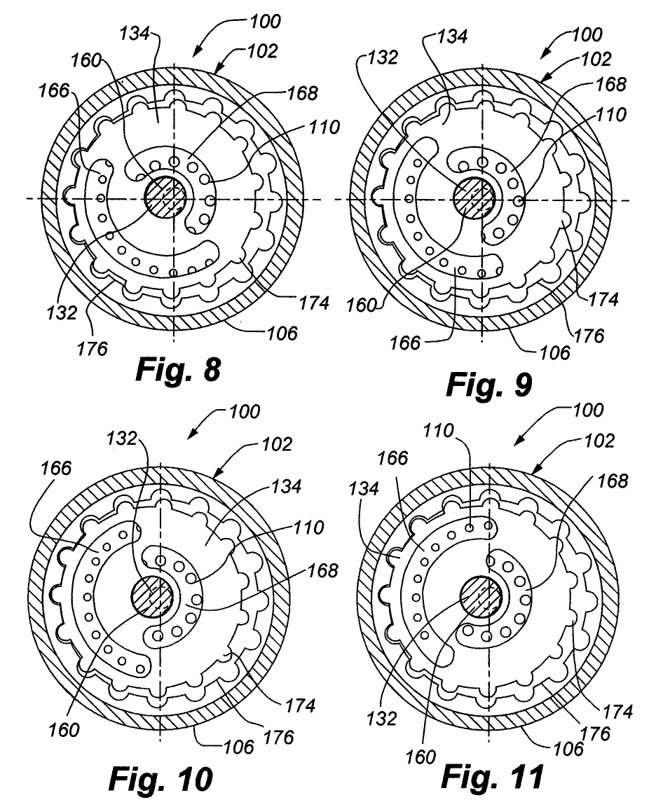

Referring to FIGS. 8-12, as the shutter 134 rotates inside the housing 102, one or more shutter fluid openings 166, 168 in the shutter 134 pass over rows of outlets 110 in the housing 102. In this manner, water may temporarily flow through the unobstructed outlets 110 located under the shutter fluid openings 166, 168. Thus, as the shutter 134 rotates, water flow through the outlets 110 is periodically interrupted as the solid portion of the shutter 134 temporarily obstructs water flow through outlets 110 located under the solid portion of the shutter 134 as depicted, for example, in FIGS. 8-12. This creates a pulsating flow of water from the showerhead 100. The period of the pulsating flow is determined, in part, by the rotational speed of the shutter 134 as further explained below.

FIG. 9 generally depicts the shutter 134 rotated clockwise within the housing 102 from the relative position occupied in FIG. 8 after the turbine 132 has completed one complete revolution in a counter-clockwise direction. FIG. 10 generally depicts the shutter 134 rotated clockwise within the housing 102 from the relative position occupied in FIG. 8 after the turbine 132 has completed two complete revolutions in a counter-clockwise direction. FIG. 11 generally depicts the shutter 134 rotated clockwise within the housing 102 from the relative position occupied in FIG. 8 after the turbine 132 has completed three complete revolutions in a counter-clockwise direction.

With reference to FIGS. 8-12, the shutter 134 may have inner and outer fluid openings 166, 168 that each extend about half way around the shutter 134. The inner and outer fluid openings 166, 168 may generally be formed on opposing halves of the shutter 134. The housing 102 also may include an inner and outer circular row of outlets 110. The inner fluid opening 168 of the shutter may overlap at least part of the inner circular row of outlets 110, while the outer fluid opening 166 may overlap at least part of the outer circular row of outlets 110. When the shutter fluid openings 166, 168 are positioned over certain outlets 110, water flows through these unobstructed outlets 110 to exit the showerhead 100. When an outlet 110 is not aligned with at least one of the shutter fluid openings 166, 168, water flow is blocked through that outlet 110. Thus, as the shutter 134 rotates, water flow through the outlets 110 may be interrupted in a sequence. This may, for example, produce a relatively low speed, periodic interruption of water flow through each row of outlets 110.

As previously discussed, for the embodiment depicted in FIGS. 1-15, there are 15 gear teeth on the shutter 134 and 16 gear teeth in the housing 102 causing the shutter 134 to rotate in a direction opposite the turbine 132 at a rate 1/15^{th} that of the turbine 132. The period of the pulsating flow of water through an outlet 110 is a direct multiple of the speed reduction times the turbine speed. Thus, if water flow through the showerhead 100 causes the turbine 132 to spin at 60 revolutions per second, the shutter 134 will rotate at a rate of 4 revolutions per second. This results in a period of the pulsating flow through an outlet 110 of about 0.25 seconds, which may simulate the feel of a hand massage. As yet another example, if the turbine 132 rotates at 50 revolutions per minute and the speed reduction is 1/10^{th}, the shutter 134 will rotate at a rate of five revolutions per minute. This results in a period of the pulsating flow through an outlet 110 of about 0.20 seconds. The foregoing examples are merely illustrative and are not intended to imply or require a particular speed reduction, turbine speed, or pulse time.

The aforementioned pulse time represents the period of time for one complete cycle of flow through an outlet 110. In other words, the time it takes for water to start flowing through an outlet 110, stop flowing through the outlet 110, and then start flowing again through the outlet 110. The ratio of the amount of time that water flows and does not flow through an outlet during a single cycle is a function of the length of the shutter fluid opening. As the length of the shutter fluid opening increases, the ratio of the time water flows through the associated outlet 110 to the time it does not flow through the outlet 110 increases. For example, if a shutter fluid opening has a length that extends approximately one-half of the circumference of the shutter 134 as shown, for example, in FIGS. 12-15, the ratio of the time water flows through an outlet 110 to not flowing through the outlet 110 will be approximately 1:1. As another example, if a shutter fluid opening has a length that extends approximately one-quarter of the circumference of the shutter 134, the ratio of the time water flows through an outlet 110 to not flowing through the outlet 110 will be approximately 1:3. The foregoing examples are merely illustrative and are not intended to imply any particular length or ratio of flow time during a single cycle for a showerhead.

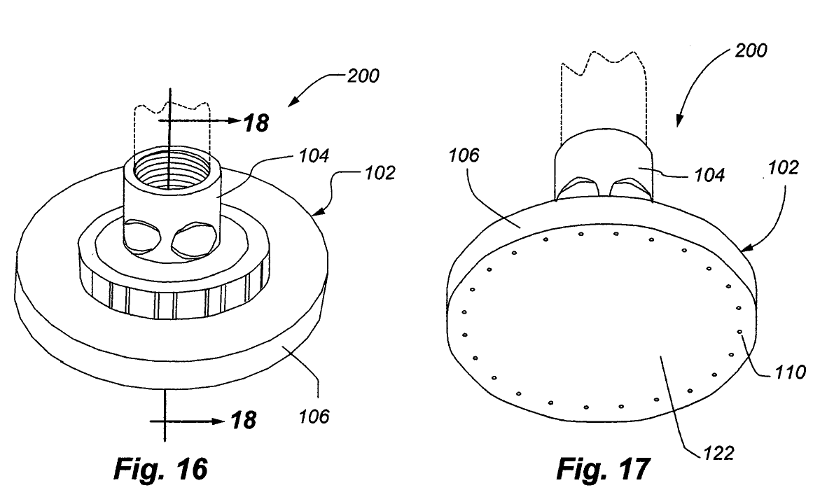

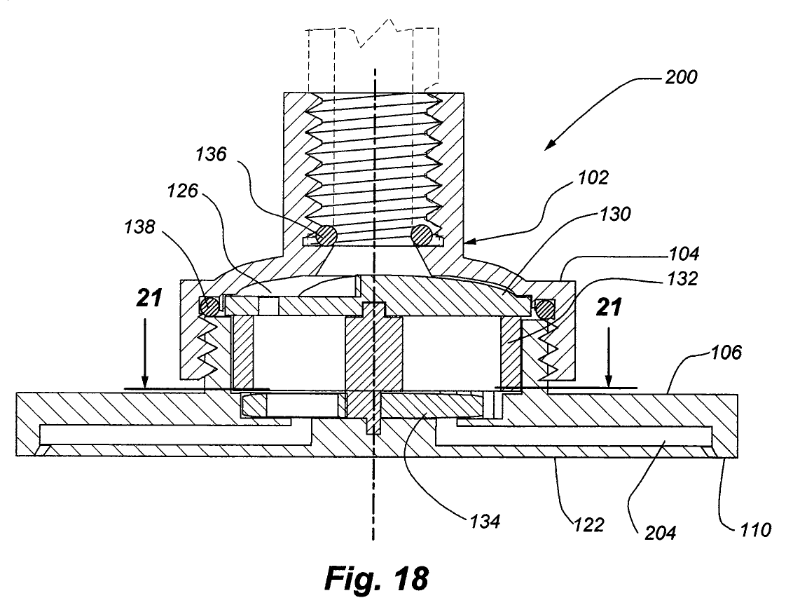

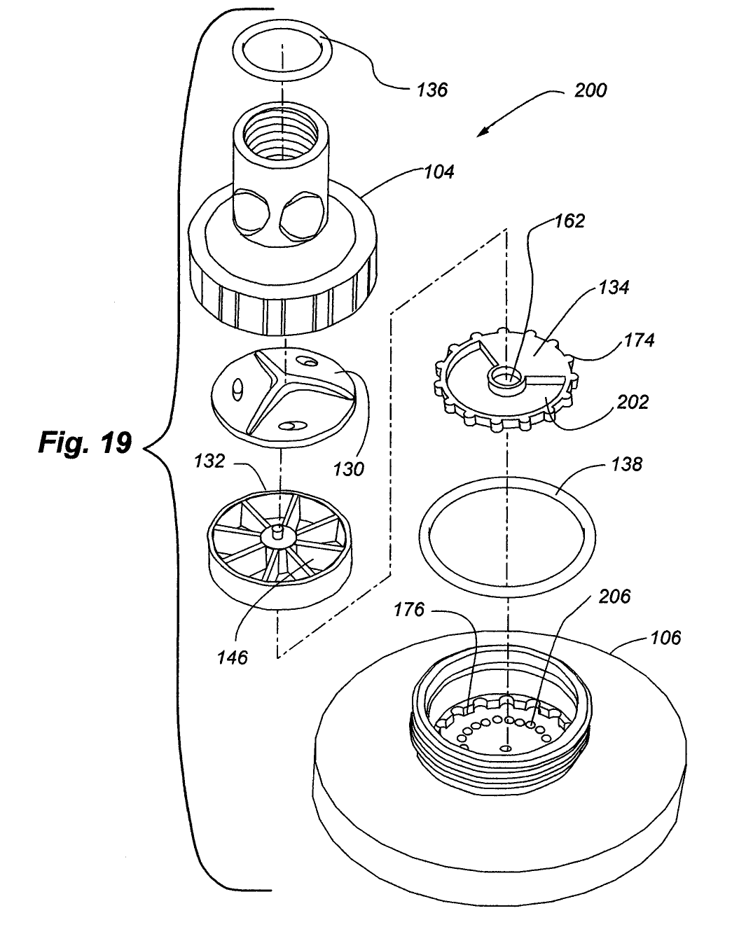

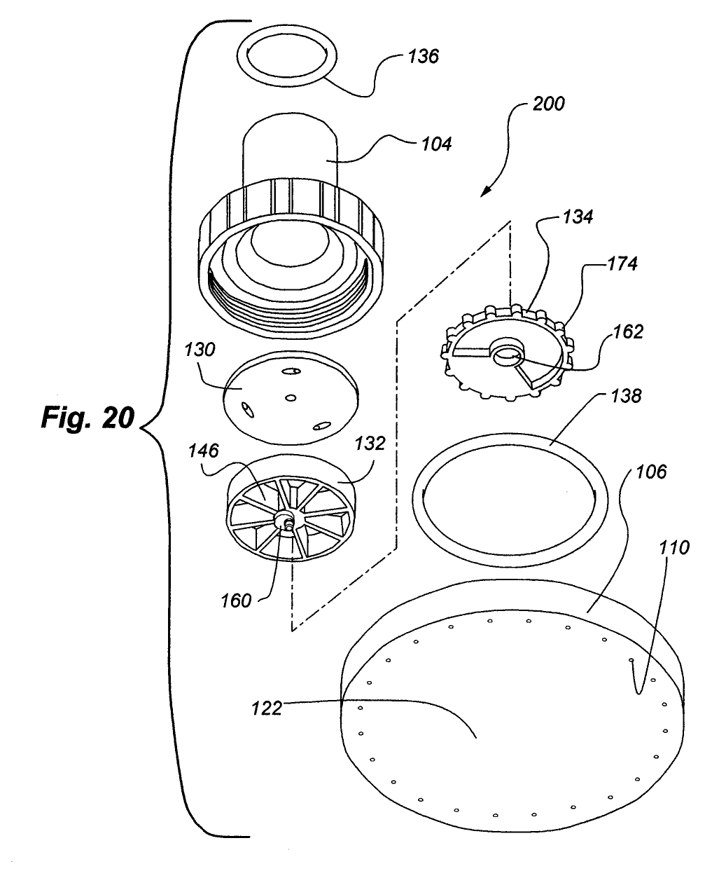

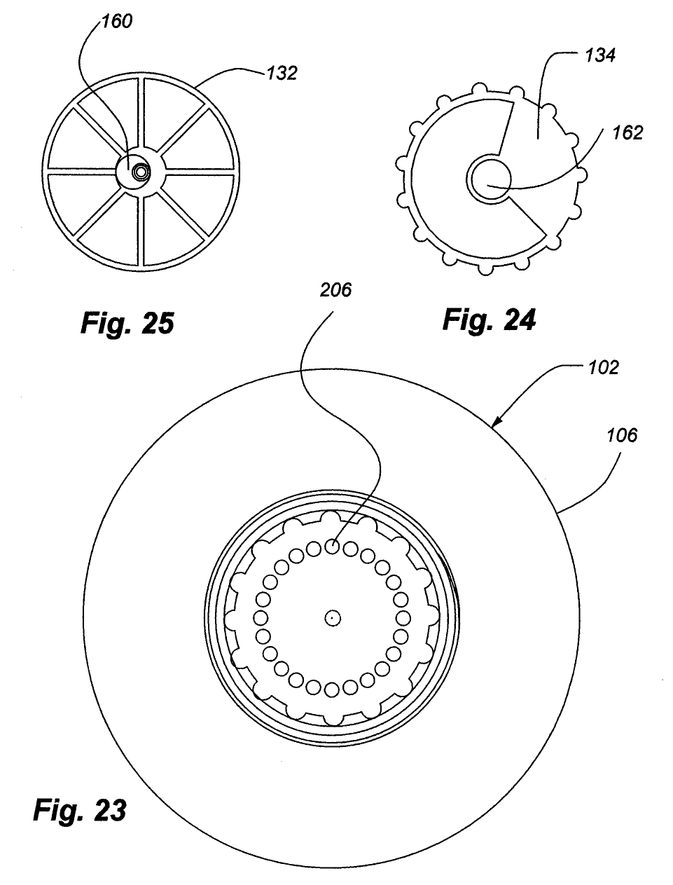

FIGS. 16-25 depict various views of a second embodiment of a showerhead 200. The second showerhead 200 is similar in structure and operation to the first showerhead 100 and like numbers for the second showerhead 200 may be used for similar or like elements of the first showerhead 100. Like the first showerhead 100, the second showerhead 200 may include a turbine 132, a jet disk 130, a shutter 134 and a housing 102. In this particular embodiment, the shutter 134 may include one fluid opening 202 that extends about two-thirds the way around the shutter 134, as shown, for example, in FIGS. 19-20. The showerhead 200 may also include one or more seal members 136, 138, such as a fluid inlet seal member 136 and housing seal member 138 as shown, for example, in FIGS. 18-20. The fluid inlet seal member 136 and the housing seal member 138 may be similar to the corresponding seal members 136, 138 described for the first showerhead 100.

Like the first embodiment, the housing 102 for the second showerhead 200 may include upper and lower housing portions 104, 106 threadedly joined as shown, for example, in FIG. 18, or joined by any other known connection method or combination thereof. Also like the housing 102 for the first showerhead 100, the housing 102 for the second showerhead 200, although shown as having a particular shape in the figures, may be formed into any desired shape and may be formed from any desired number of portions or components. The housing 102 may include one row of outlets or nozzles 110 as shown in FIG. 20, which may be fluidly connected the housing chamber or cavity 126 via fluid passages or conduits 204 defined in a base 122 of the lower housing portion 106 as shown, for example, in FIGS. 18 and 19. Each fluid passage 204, in turn, may include a fluid passage opening 206 defined in an upper surface of the base 122 for fluidly joining the fluid passage to the housing chamber or cavity 126. For a given sized turbine 132 and/or chamber 126, the fluid conduits allow for the use of a larger showerhead 200 to create a larger diameter spray pattern from the showerhead 200.

Like the shutter 134 for the first showerhead 100, the shutter 134 for the second showerhead 200 may include a generally circular and planar (or any other shaped) body including at least one shutter fluid opening 202. Also like the shutter 134 for the first showerhead 100, the shutter 134 for the second showerhead 200 may include a cam opening 162 along its central axis for receiving an eccentric cam 160 formed on the turbine 132. The shutter 134 may thus spin or rotate about the central axis of the eccentric cam 160 as the turbine 132 rotates in a manner similar to the shutter 134 for the first showerhead 100. As the turbine 132 spins, the motion of the eccentric cam 160 causes the shutter 134 to rotate about the center of the eccentric cam 160 such that the portions of the shutter's periphery that contacts the housing 102 changes as described in more detail above for the first showerhead 100.

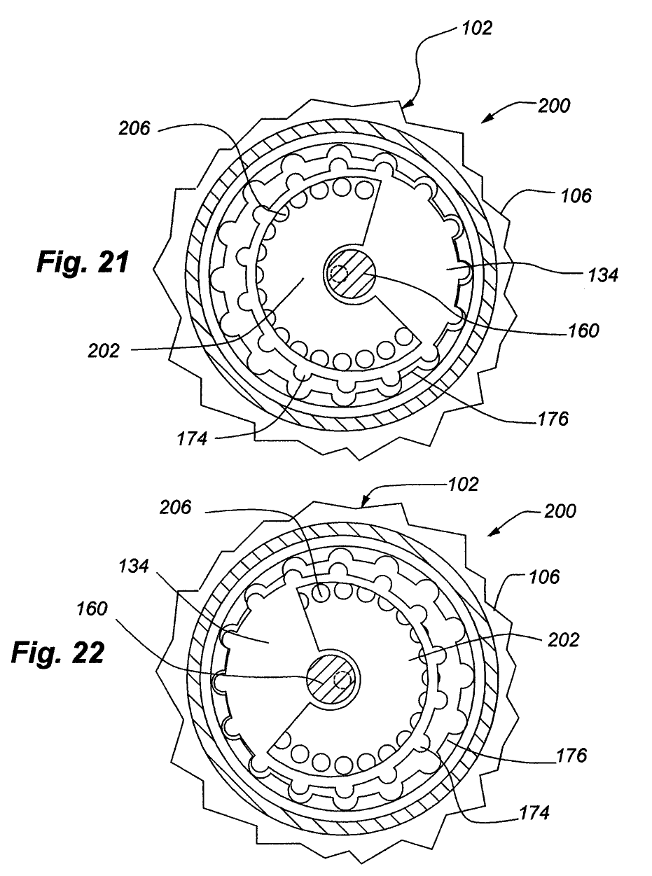

The shutter 134 and housing 102 may each include one or more gear teeth, as described above. For example, and as illustrated in FIGS. 21 and 22, the shutter 134 may have 15 gear teeth and the housing may have 16 gear teeth that engage the shutter teeth. Accordingly, the shutter 134 rotates inside the housing 102 in an opposite direction with respect to the turbine 132 at a rate 1/15^{th} the speed of the turbine 132. FIG. 22 generally depicts the shutter 134 rotated clockwise within the housing 102 from its position in FIG. 21.

As depicted in FIGS. 21 and 22, as the shutter 134 rotates, the flow of water through the fluid passage openings 206, and thus the outlet 110 in fluid communication with a respective fluid passage opening 206, is interrupted as the solid portion of the shutter 134 passes over a fluid passage opening 206. When the shutter fluid opening 202 is over a fluid passage opening 206, water flows through the associated fluid passage 204 and exits the showerhead 200 through the outlet 110 associated with the fluid passage 204. When a fluid passage opening 206 is not aligned with the shutter fluid opening 202, water flow ceases through the outlet 110 in fluid communication with the fluid passage opening 206. Thus, as the shutter 134 rotates, water flow through the outlets 110 may be interrupted in a sequence. This may, for example, produce a relatively low speed, periodic interruption of water flow through each outlet 110. Other embodiments may employ more or fewer rows of outlets 110 in the housing 102 and may employ more or fewer shutter fluid openings 202 to create a variety of low speed pulsating water flow patterns. As an example, the shutter fluid openings 202 may be radially aligned with one another to produce a spray pattern. As another example, the outlets 110 may be grouped within one or more sectors on the housing base 122 and/or spaced non-uniformly within one or more rows.

Water flow through the second showerhead 200, at least to the bottom side of the shutter 134, generally proceeds as previously described above for the first showerhead 100. Also as previously described above for the first showerhead 100, selective engagement of the shutter engagement feature 174 with the housing engagement feature 176 causes the shutter 134 to rotate at a slower speed than the turbine 132. As the shutter 134 rotates inside the chamber 126 of the housing 102, one or more shutter fluid openings 202 may pass over one or more rows of fluid passage openings 206 in the housing 102. This permits water to temporarily flow through the unobstructed fluid passage openings 206. Thus, as the shutter 134 rotates, water flow through the outlets or nozzles 110 is periodically interrupted as the solid portion of the shutter 134 temporarily obstructs the water flow through those outlets 110 in fluid communication with fluid passage openings 206 located under the solid portion of the shutter 134. This creates a pulsating flow of water from the showerhead 200.

Various embodiments of the second showerhead 200 may use the same or differing numbers of fluid passage openings 206 to outlets or nozzles 110. For example, each outlet 110 may be in fluid communication with a single fluid passage opening 206, or an outlet 110 may be in fluid communication with two or more fluid passage openings 206, or vice versa.

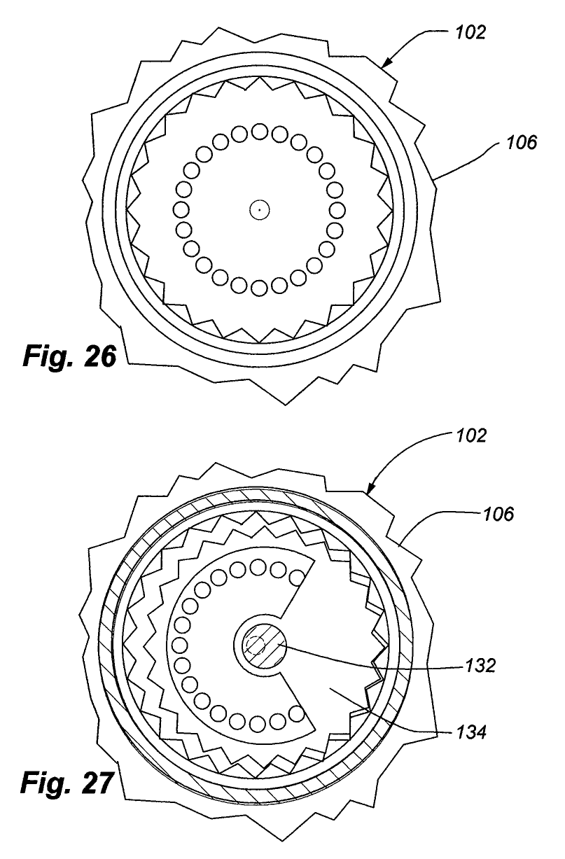

Other embodiments of the showerhead, including variations of the first and second showerheads 100, 200, may use other types of engageable features on the shutter 134 and the housing 102 to cause the shutter 134 to rotate at a different rate than the turbine 132. For example, the shutter 134 may have external, involute teeth and the housing 102 may have matching internal, involute housing teeth. As another example, the shutter 134 may have saw tooth features that mate to saw tooth cuts in the housing 102 as depicted in FIGS. 26 and 27. In yet another example, circular pins extending radially from the periphery of the shutter 134 may mate with slots in the housing 102. As yet another example, slots in the shutter 134 may mate with pins extending radially inward from the housing 102. As still yet another example, circular cuts in the periphery of the shutter 134 may engage pins in the housing 102. The foregoing examples are merely illustrative and are not intended to limit the engageable features for the shutter 134 and/or the housing 102 to any particular feature, or to limit other mechanisms for causing the shutter 134 to rotate at different rate than the turbine 132.

Further, the engagement of the shutter 134 to the housing 102 is generally not limited to the use of engagement features 174, 176 to implement the speed reduction mechanism or to otherwise change the rotational speed of the shutter 134 relative to the turbine 132. In some embodiments, the shutter 134 may be made to lag the turbine 132 through friction engagement between the shutter 134 and housing 102. In such embodiments, the speed reduction may be determined by the ratio of the difference in the diameters of the housing 102 and the shutter 134, divided by the diameter of the shutter 134 (presuming minimal to no slippage between the shutter 134 and the housing 102).

The housing 102, shutter 134, jet disk 130, turbine 132, and other elements for any embodiment of a showerhead may be integrally formed or may be made of two or more separate components that are joined together by mechanical fasteners, sonic or heat welds, adhesives, chemical bonds, any other suitable method, or any combination thereof. Further, the components may be formed from any suitable material, including, but not limited to, plastics, metals, elastomers, and so on.

All directional references (e.g., upper, lower, upward, downward, left, right, leftward, rightward, top, bottom, above, below, vertical, horizontal, clockwise, and counterclockwise) are only used for identification purposes to aid the reader's understanding of the examples of the invention, and do not create limitations, particularly as to the position, orientation, or use of the invention unless specifically set forth in the claims. Joinder references (e.g., attached, coupled, connected, joined and the like) are to be construed broadly and may include intermediate members between the connection of elements and relative movement between elements. As such, joinder references do not necessarily infer that two elements are directly connected and in fixed relation to each other.

In some instances, components are described by reference to “ends” having a particular characteristic and/or being connected with another part. However, those skilled in the art will recognize that the present invention is not limited to components which terminate immediately beyond their point of connection with other parts. Thus the term “end” should be broadly interpreted, in a manner that includes areas adjacent rearward, forward of or otherwise near the terminus of a particular element, link, component, part, member or the like. In methodologies directly or indirectly set forth herein, various steps and operations are described in one possible order of operation but those skilled in the art will recognize the steps and operation may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A showerhead, comprising:
a housing defining a chamber in fluid communication with a fluid inlet and at least one fluid outlet;
a turbine received within the chamber; and
a shutter received within the chamber and operatively associated with the turbine, wherein:
rotation of the turbine causes rotation of the shutter;
a rotation rate of the shutter is less than a rotation rate of the turbine; and
as the shutter rotates, the shutter fluidly connects and disconnects the fluid inlet and the at least one fluid outlet.

2. The showerhead of claim 1, wherein:
the housing includes a first engagement feature;
the shutter includes a second engagement feature; and
engagement of the first engagement feature with the second engagement feature causes the rotation rate of the shutter to be less than the rotation rate of the turbine.

3. The showerhead of claim 2, wherein the first engagement feature comprises at least one gear tooth.

4. The showerhead of claim 2, wherein the second engagement feature comprises at least one gear tooth.

5. The showerhead of claim 2, wherein the first engagement feature comprises a first number of gear teeth, and the second engagement feature comprises a second number of gear teeth.

6. The showerhead of claim 5, wherein the first number is greater than the second number.

7. The showerhead of claim 2, wherein the shutter comprises a substantially circular disk, and the second engagement feature is positioned proximate a periphery of the disk.

8. The showerhead of claim 1, wherein:
the shutter includes at least one opening, and
the at least one opening fluidly connects and disconnects the fluid inlet and the at least one fluid outlet.

9. The showerhead of claim 1, wherein the at least one fluid outlet comprises a first row of outlets and a second row of outlets.

10. The showerhead of claim 9, wherein:
the shutter includes a first opening and a second opening;
the first opening fluidly connects and disconnects the first row of outlets with the fluid inlet; and
the second opening fluidly connects and disconnects the second row of outlets with the fluid inlet.

11. The showerhead of claim 1, wherein the turbine and the shutter rotate in opposite directions.

12. The showerhead of claim 1, wherein the turbine and the shutter rotate in the same direction.

13. The showerhead of claim 1, wherein the rotation rate of the shutter is no greater than approximately 1/15^{th} of the rotation rate of the turbine.

14. The showerhead of claim 1, wherein the turbine includes an eccentric cam, and the shutter includes an opening for receiving the cam.

15. The showerhead of claim 1, wherein a center of the shutter moves in a substantially circular path around a center of the turbine.

16. The showerhead of claim 1, further comprising a jet disk operatively associated with the turbine, and the jet disk includes at least one jet.

17. The showerhead of claim 1, wherein:
the shutter comprises a disk and an integer number of first features distributed around a periphery of the disk;
the housing comprises an integer number of second features incorporated within an inner surface of the housing defining the chamber;
the number of first features is different than the number of second features; and
rotation of the shutter selectively engages the first features with the second features.

18. The showerhead of claim 17, wherein the number of first features is less than the number of second features.

19. The showerhead of claim 18, wherein the rate of rotation of the shutter is the rate of rotation of the turbine multiplied by a speed reduction factor.

20. The showerhead of claim 19, wherein the speed reduction factor is the difference between the number of second features and the number of first features divided by the number of first features.
